(19) United States
(12) Patent Application Publication
(10) Pub. No.: US 2025/0354794 A1
(43) Pub. Date: Nov. 20, 2025

(54) MAGNETIC ANGULAR-POSITION MEASURING DEVICE

(71) Applicant: DR. JOHANNES HEIDENHAIN GmbH, Traunreut (DE)

(72) Inventors: Johannes Schneider, Traunstein (DE); Johannes Hilverkus, Marquartstein (DE)

(21) Appl. No.: 19/204,635

(22) Filed: May 12, 2025

(30) Foreign Application Priority Data
May 14, 2024 (DE) 10 2024 001 566.3

(51) Int. Cl. G01B 7/30; G01D 5/14; G01D 5/16

(52) U.S. Cl. CPC G01B 7/30; G01D 5/145; G01D 5/16

(57) ABSTRACT

An angular-position measuring device, including a first component group and a second component group. The first component group and the second component group are arranged so as to be rotatable relative to one another about an axis. The first component group includes a position detector. The position detector is mounted on a circuit board. The second component group has a magnet arrangement. The magnet arrangement includes a plurality of magnets arranged in a form of a Halbach array around the axis, or the magnet arrangement is configured as a Halbach cylinder. The magnet arrangement is spaced apart from the position detector, the position detector being configured to detect an angular position based on a rotation of the magnet arrangement relative to the circuit board.

### CROSS REFERENCE TO RELATED APPLICATIONS

This application claims benefit to German Patent Application No. DE 10 2024 001 566.3, filed on May 14, 2024, which is hereby incorporated by reference herein.

### FIELD

The invention relates to a magnetic angular-position measuring device.

### BACKGROUND

Magnetic angular-position measuring devices are used, for example, as rotary encoders, which are based on a magnetic sensing principle, for determining the angular position of two machine parts that are rotatable relative to one another.

Often, these measuring devices or measuring instruments are used for electrical drives to determine the relative movement or relative position of relevant machine parts. In this case, the position values generated are supplied to subsequent electronics for actuating the drives by way of a corresponding interface arrangement.

For many applications of angular-position measuring devices, it is important to capture at least numbers of revolutions or rough positions even in the event of temporary power outages, and to store them in a non-volatile manner. Often, what are known as multi-turn angular-position measuring devices are used for this purpose, which allow for absolute position determination over many revolutions.

DE 10 2022 106 330 A1 describes a magnetic measuring device for measuring an angular position, comprising a domain-wall memory as a multi-turn sensor. The domain walls thereof can be moved by one or two permanent magnets that are rotatable relative to the domain-wall memory.

### SUMMARY

In an embodiment, the present disclosure provides an angular-position measuring device, comprising a first component group and a second component group. The first component group and the second component group are arranged so as to be rotatable relative to one another about an axis. The first component group comprises a position detector. The position detector is mounted on a circuit board. The second component group has a magnet arrangement. The magnet arrangement comprises a plurality of magnets arranged in a form of a Halbach array around the axis, or the magnet arrangement is configured as a Halbach cylinder. The magnet arrangement is spaced apart from the position detector, the position detector being configured to detect an angular position based on a rotation of the magnet arrangement relative to the circuit board.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a sectional view of an angular-position measuring device;

FIG. 2 illustrates a plan view of magnets of a second component group;

FIG. 3 illustrates a plan view of a domain-wall conductor; and

FIG. 4 illustrates a plan view of a Halbach cylinder of the second component group, according to an embodiment.

### DETAILED DESCRIPTION

In an embodiment, the present disclosure provides a magnetic angular-position measuring device by which precise, reliable operational performance can be achieved and which is economical to produce.

According to present disclosure, the magnetic angular-position measuring device comprises a first component group and a second component group, the component groups being arranged so as to be rotatable relative to one another in a measurement direction or in a circumferential direction. The first component group comprises a position detector that is mounted on a circuit board. The second component group has a magnet arrangement. The magnet arrangement comprises a plurality of magnets arranged in the form of a Halbach array around the axis. Alternatively, the magnet arrangement can be configured as a Halbach cylinder. Furthermore, the magnet arrangement is spaced apart from the position detector such that, when the magnet arrangement rotates relative to the circuit board, a relative angular position between the first component group and the second component group can be detected by the position detector.

In particular, the position detector can be offset from the magnet arrangement in the axial direction. Alternatively or additionally, the circuit board can be offset from the magnet arrangement in the axial direction.

The axis advantageously intersects or passes through the position detector. An arrangement in which the axis (of rotation) intersects the position detector is often referred to as an “on-axis” configuration.

The magnetization direction can be understood as the direction of a connecting line between the south pole and the north pole of a magnet. A magnetization angle at a particular point on the circumference or at a particular circumferential angle is an angle between mutually parallel lines and the magnetization direction.

The magnet arrangement is advantageously configured such that, at a first circumferential angle, the magnetization is oriented so as to have a first magnetization angle. At a second circumferential angle, the magnetization has a second magnetization angle. The first magnetization angle is rotated relative to the second magnetization angle by an angle equal to twice the difference between the first circumferential angle and the second circumferential angle.

The Halbach cylinder can be configured as a single piece or can be assembled from a plurality of segments.

In an embodiment of the present disclosure, the first component group comprises a domain-wall memory. The domain-wall memory is also mounted on a circuit board such that, when the magnet arrangement rotates relative to the circuit board, revolutions can be counted by the domain-wall memory. In this embodiment, therefore, the magnet arrangement is used not only as an angular scale, so to speak, for relatively fine determination of the relative angular position between the first component group and the second component group, but also for the counting of revolutions by the domain-wall memory.

The first component group advantageously comprises a housing which is used inter alia for shielding against interference fields and which is configured to circumferentially or encirclingly enclose the magnet arrangement and advantageously also circumferentially enclose the position detector and/or the domain-wall memory. The housing can furthermore be configured to also axially enclose the magnet arrangement and/or also the position detector and/or the domain-wall memory. Thus, under suitable conditions, the shielding effect against interference fields can be enhanced. In particular, the housing can engage around the second component group.

In an embodiment of the present disclosure, an electrical coupling is fastened directly to the circuit board and in particular extends through the housing, such that the angular-position measuring device can be electrically connected to a further electronic device by means of a plug connection. In particular, the electrical coupling can be directly contacted on the circuit board.

The position detector advantageously comprises at least one magnetoresistive element that is based for example on an AMR, GMR, or TMR effect. The position detector could alternatively or additionally also comprise at least one Hall element. The sensing is thus based on a magnetic principle, for which reason the angular-position measuring device is referred to as a magnetic angular-position measuring device.

At least two of the plurality of magnets arranged as a Halbach array are advantageously configured as mutually identical or structurally identical magnets. The identical magnets can in particular each be provided in an arrangement rotated relative to one another. In particular, the magnets are rotated in each case about virtual lines extending in parallel with the axis about which the first component group is rotatable relative to the second component group.

The Halbach cylinder and/or the magnets can be produced by means of a sintering process or a casting process. Alternatively, the material of the Halbach cylinder and/or of the magnets comprises plastics material having a magnetizable filler. In particular, the magnets and/or the Halbach cylinder can be produced by means of a pressing process or injection molding process.

The domain-wall memory comprises a domain-wall conductor running in a face. Domain-wall conductors configured substantially as an open spiral are known, as are those having a closed shape.

A domain-wall conductor comprises a magnetizable material and, in the context of the present disclosure, is configured in particular as at least one conducting trace or conducting track or a nanowire. In the domain-wall conductor, information can be stored in the form of regions (domains) of opposite magnetization. The domains are separated along the conducting trace by what are known as domain walls, which can be displaced by magnetic fields, with the positions of the domains changing in the process.

Advantageously, the domain-wall memory comprises an in particular planar substrate, and the domain-wall conductor is configured as a conducting track on the substrate. In this case, the face in which the domain-wall conductor runs is planar.

The structural width of the domain-wall conductor is usually less than 500 nm, often less than 300 nm, and the thickness or layer thickness of the domain-wall conductor is less than 60 nm. The domain-wall memory can comprise a plurality of domain-wall conductors.

The domain-wall memory furthermore has readout elements by which the local magnetization status of the domain-wall conductor (at the position of each readout element) can be determined. A magnetization status of each domain-wall conductor can therefore be determined by the readout elements. The readout elements are arranged in a fixed manner with respect to the domain-wall conductor. GMR or TMR sensors can be used as readout elements, for example.

Further details and advantages of the angular-position measuring device according to the present disclosure will become apparent from the following description of embodiment examples with reference to the accompanying drawings.

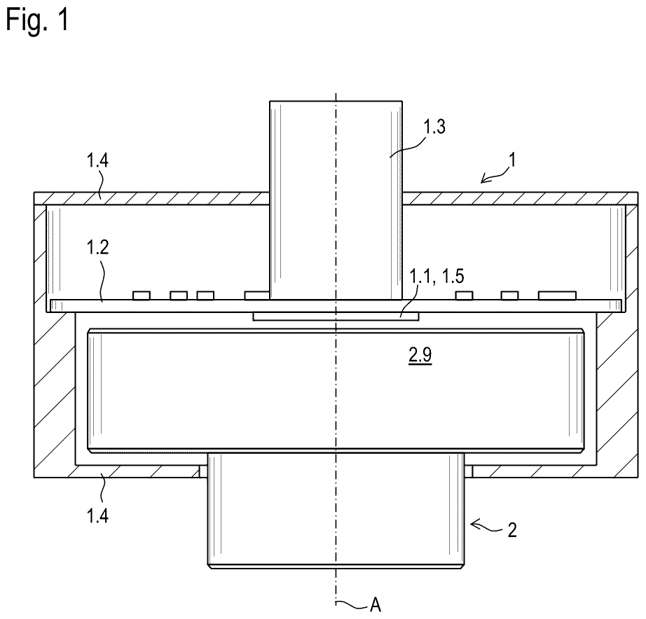

FIG. 1 shows an angular-position measuring device that comprises a first component group 1 and a second component group 2, the component groups 1, 2 being arranged so as to be rotatable relative to one another about an axis A. The first component group comprises a circuit board 1.2, a position detector 1.5, a domain-wall memory 1.1, an electrical coupling 1.3, and a housing 1.4.

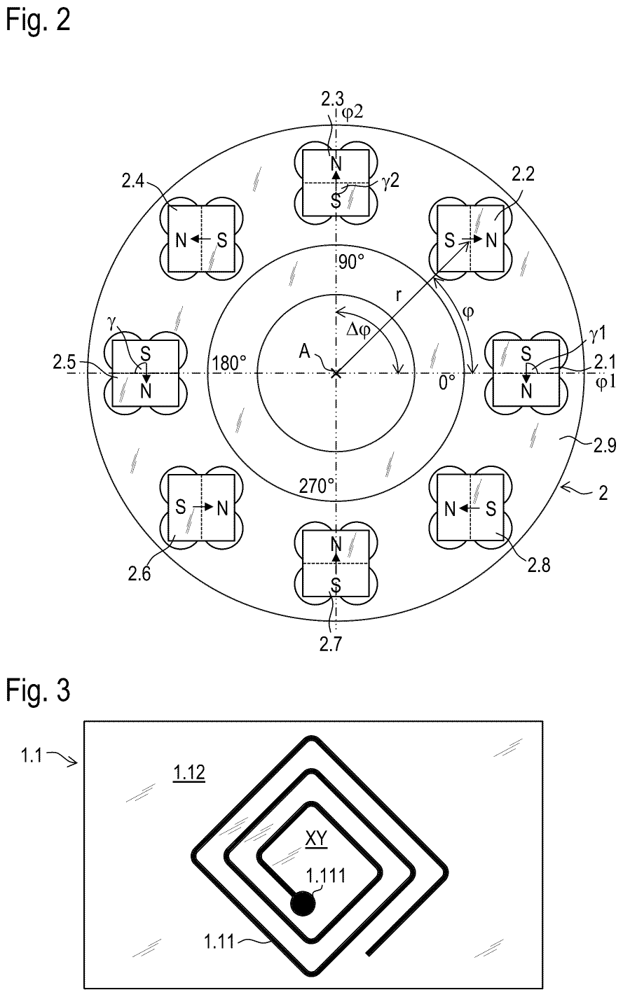

In the first embodiment example presented, the second component group 2 comprises a support body 2.9 which, in this case as per FIG. 2, has on the end face a magnet arrangement that comprises a plurality of magnets 2.1 to 2.8. The magnets are embedded in the support body 2.9, which has a central bore having a shoulder, which bore can receive a preferably non-magnetic fastening screw. The support body 2.9 can for example be produced from a plastics material.

The magnets 2.1 to 2.8 are arranged in the form of a Halbach array. In the embodiment example presented, eight identical cuboidal magnets 2.1 to 2.8 are arranged at intervals along a circular line, or at different circumferential angles φ, the arrangement corresponding to what is known as a k=2 Halbach array. In FIG. 2, arrows are used to illustrate the magnetization directions over the circumference. The magnetization direction can be understood as the direction of a connecting line between the south pole and the north pole of a magnet. The magnetization directions are summarized in the following table:

TABLE 1

| Magnet | Circumferential angle φ | Magnetization angle g |
|---|---|---|
| 2.1 | 0° | 270° |
| 2.2 | 45° | 0° |
| 2.3 | 90° | 90° |
| 2.4 | 135° | 180° |
| 2.5 | 180° | 270° |
| 2.6 | 225° | 0° |
| 2.7 | 270° | 90° |
| 2.8 | 315° | 180° |

As shown in the table, the magnetization angle γ, which is the angle between the arrow direction of the individual magnets 2.1 to 2.8 and a line having a constant orientation, changes along a circumferential direction at twice the rate (k=2) of the circumferential angle o that defines the angular positions of the magnets 2.1 to 2.8 along the circumferential direction. In the embodiment example presented, the magnets 2.1 to 2.8 are arranged in each case at 45° intervals (Δφ=) 45° over the circumference. For Δφ=45°, the magnetization angle changes by Δγ=90°. In general, the following applies here:

$$Δγ = 2 \cdot Δφ .$$

For example, at a first circumferential angle φ1=0°, there is a first magnetization angle γ1=270°. Moving further along a circumferential line to a second circumferential angle φ2, for example φ2=90°, there is a second magnetization angle γ2=90°. The first magnetization angle γ1 is then rotated relative to the second magnetization angle γ2 by an angle Δγ=180°, whereas the difference Δφ between the first circumferential angle φ1 and the second circumferential angle φ2 is 90°, i.e., Δφ=90°.

In accordance with FIG. 1, the first component group 1 has the domain-wall memory 1.1 and the position detector 1.5, which is situated in the same package as the domain-wall memory 1.1. By means of the position detector 1.5, the magnetic field of the magnet arrangement can be sensed and converted into electrical signals that contain the information relating to the angular position within one revolution. The position detector 1.5 can comprise magnetoresistive elements or, for example, Hall elements.

In accordance with FIG. 3, the domain-wall memory 1.1 comprises a domain-wall conductor 1.11 and a substrate 1.12, the domain-wall conductor 1.11 being applied to the substrate 1.12 in the form of a conducting track and running in (or on) a first face XY. At one end, the domain-wall conductor 1.11 has a domain-wall generator 1.111. In the embodiment example presented, the substrate 1.12 has a mechanically load-bearing silicon layer, the substrate 1.12 being configured in a planar manner and it being provided for the domain-wall conductor 1.11 to be part of a CMOS chip. Alternatively, the substrate can have a glass layer. The domain-wall conductor 1.11 comprises a magnetically soft material, for example a Ni—Fe alloy. The domain-wall conductor 1.11 can be configured as an open spiral, as shown in FIG. 3, or have a closed shape.

When the angular-position measuring device is in operation, the first component group 1 and the second component group 2 are opposite each other. In the embodiment example presented, the first component group 1 can be operated as the stator and the second component group 2 as the rotor.

The magnet arrangement is sensed by the position detector 1.5; this delivers electrical signals which contain the position information and which can be conducted via the electrical coupling 1.3, and then onward via a cable, to further electronics.

The domain-wall memory 1.1 is used for ensuring a multi-turn functionality, i.e., for counting many revolutions or passes.

During every quarter revolution of the second component group 2, the domain wall or walls move further. The magnetization directions within portions of the domain-wall conductor 1.11, and thus the positions of the domain walls, can be detected by the readout elements integrated in the domain-wall memory 1.1. In this way, in an angular-position measuring device, revolutions can be counted or the revolution information stored even when no auxiliary power can be used. By way of example, this is important if a shaft is moved, for example under a weight load, during a power outage. Moreover, the domain walls are displaced in a manner dependent on the direction of rotation such that the domain-wall memory 1.1 can be used reliably in applications that allow for both directions of rotation.

The sensing of the magnetic field by the position detector 1.5 yields a relatively accurate determination of the angular position within one revolution. For the absolute determination of the angular position over a plurality of revolutions (multi-turn functionality), the angular position (fine position) ascertained by the position detector 1.5 has to be synchronized with the revolution information (rough position) of the domain-wall memory 1.1.

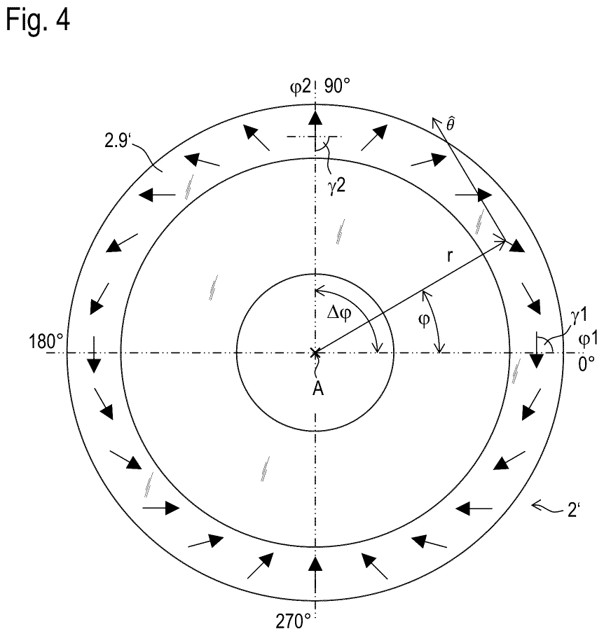

In accordance with an embodiment example illustrated in FIG. 4, a single-piece Halbach cylinder 2.9′ is used, instead of the discrete magnets 2.1 to 2.8, in the second component group 2′. Said Halbach cylinder exhibits relatively complex, in particular anisotropic, magnetization, such that its magnetization vector can be defined by the following formula:

$$\vec{M} = {M}_{r} [ cos ( ( k - 1 ) ( φ - \frac{π}{2} ) ) \hat{r} + sin ( ( k - 1 ) ( φ - \frac{π}{2} ) ) \hat{θ} ] ,$$

where
Mᵣ: magnetic remanence,
k: natural number,
φ: circumferential angle,
\hat{r}, \hat{θ}: unit vectors in polar coordinates, the directions of which are dependent on the position of the point under consideration.

For the k=2 Halbach array, the following then applies:

$$\vec{M} = {M}_{r} [ cos ( φ - \frac{π}{2} ) \hat{r} + sin ( φ - \frac{π}{2} ) \hat{θ} ]$$

In FIG. 4, arrows are used to illustrate the magnetization directions over the circumference.

In this case, too, therefore, the magnet arrangement is configured such that the first magnetization angle γ1 is rotated relative to the second magnetization angle γ2 by an angle Δγ equal to twice the difference Δφ between the first circumferential angle φ1 and the second circumferential angle φ2:

$$2 \cdot Δφ = γ1 - γ2 = Δγ$$

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An angular-position measuring device, comprising:
a first component group; and
a second component group,
wherein the first component group and the second component group are arranged so as to be rotatable relative to one another about an axis,
wherein the first component group comprises a position detector,
wherein the position detector is mounted on a circuit board,
wherein the second component group has a magnet arrangement, wherein the magnet arrangement:
comprises a plurality of magnets arranged in a form of a Halbach array around the axis, or
is configured as a Halbach cylinder, and
wherein the magnet arrangement is spaced apart from the position detector, the position detector being configured to detect an angular position based on a rotation of the magnet arrangement relative to the circuit board.

2. The angular-position measuring device according to claim 1, wherein the magnet arrangement is configured such that a magnetization of the magnet arrangement has a first magnetization angle at a first circumferential angle and has a second magnetization angle at a second circumferential angle, and wherein the first magnetization angle is rotated relative to the second magnetization angle by an angle equal to twice the difference between the first circumferential angle and the second circumferential angle.

3. The angular-position measuring device according to claim 1, wherein the first component group comprises a domain-wall memory, and wherein the domain-wall memory is configured to count revolutions of the magnet arrangement relative to the domain-wall memory.

4. The angular-position measuring device according to claim 3, wherein the domain-wall memory is mounted on the circuit board.

5. The angular-position measuring device according to claim 1, wherein the first component group comprises a housing, and wherein the housing is configured to circumferentially enclose the position detector and the magnet arrangement so as to shield against interference fields.

6. The angular-position measuring device according to claim 5, wherein the housing circumferentially encloses the domain-wall memory so as to shield against interference fields.

7. The angular-position measuring device according to claim 1, wherein an electrical coupling is fastened to the circuit board.

8. The angular-position measuring device according to claim 1, wherein the position detector comprises a magnetoresistive element or a Hall element.

9. The angular-position measuring device according to claim 1, wherein at least some of the plurality of magnets arranged as the Halbach array are configured as mutually identical magnets.
